(19) United States
(12) Patent Application Publication
(10) Pub. No.: US 2005/0235801 A1
(43) Pub. Date: Oct. 27, 2005

(54) Separate automatic player driving keys and pedals of keyboard musical instrument

(75) Inventors: Shigeru Muramatsu, Shizuoka-ken (JP); Katsuo Ito, Shizuoka-ken (JP)

Correspondence Address: HARNESS, DICKEY & PIERCE, P.L.C., P.O. BOX 828, BLOOMFIELD HILLS, MI, 48303, US

(73) Assignee: Yamaha Corporation, Shizuoka-ken (JP)

(21) Appl. No.: 11/091,866

(22) Filed: Mar. 28, 2005

(30) Foreign Application Priority Data
Apr. 21, 2004 (JP) 2004-124965

(51) Int. Cl. G10F 1/02

(52) U.S. Cl. 84/13

(57) ABSTRACT

A separate automatic player is independent of a piano, and stands in front of the piano for an automatic playing; the separate automatic player includes a key driver unit, a pedal driver unit and a framework on which the key driver unit and pedal driver unit is carried; the key driver unit has an array of key actuators so as to selectively depress and releases the black and white keys, and a pair of side elevators and a rotary unit is provided between the framework and the array of key actuators; the side elevators bring the plunger heads of the key actuators into contact with the upper surfaces of the black and white keys, and the rotary unit makes the plungers vertical to the upper surfaces so that the key actuators exert force on the black and white keys at the magnitude exactly equivalent to pieces of music data.

### FIELD OF THE INVENTION

This invention relates to an automatic player and, more particularly, to an automatic player for performing a piece of music on a keyboard musical instrument.

### DESCRIPTION OF THE RELATED ART

An automatic player piano is an example of a hybrid keyboard musical instrument. The automatic player piano is broken down into an acoustic piano and a built-in automatic player, and the built-in automatic player is installed in the acoustic piano before delivery to users. In other words, the manufacturer completes the automatic player piano, and sells it in the market. However, there are a lot of acoustic pianos at homes. The owners may wish to enjoy the automatic playing on their acoustic pianos.

Separate automatic players have been proposed to those owners. The owners, who wish to enjoy the automatic playing on their acoustic pianos, purchase the separate automatic players, and install them on their acoustic piano. When the owners instruct the separate automatic players to perform a piece of music, the automatic player fingers the piece of music on the keyboard so that the owners enjoy the automatic playing.

A typical example of the separate automatic player is disclosed in Japan Utility Model Application laid-open Sho 64-4497. The prior art separate automatic player includes a cabinet with legs, an array of key actuators downwardly projecting from the housing and a controller for selectively actuating the key actuators. The legs are placed on the key blocks, which are exposed to the outside on both sides of the keyboard, and the legs keep the housing extending over the keys. The housing is equipped with a height adjuster, and the user adjusts the key actuators to relative positions with respect to the keys by manipulating the height adjuster. The controller makes the driving circuit sequentially supply driving signals to the key actuators, and the plungers downwardly project and are retracted so as to depress and release the keys.

However, the prior art separate automatic player is available only for a certain model. In other words, the prior art separate automatic player is customized to the certain model of acoustic piano. This is because of the fact that acoustic pianos have individual dimensions. For example, grand pianos are different in dimensions from upright pianos and small-sized grand pianos. The distance between the key blocks is different between the certain model of acoustic piano and other models of acoustic piano, and the keyboards are differently inclined.

Another problem inherent in the prior art automatic player is that the piece of music is imperfectly reenacted. The reason for the imperfection is that the prior art automatic player does not have any pedal actuator. Even though a pianist selectively steps on the pedals in the original performance, the prior art automatic player can not move the pedals in the automatic playing so that the listeners feel the piece of music plane.

The present inventors searched a database for another prior art, and found U.S. Pat. No. 4,206,677. In the U.S. patent, Ramsey discloses a pedal actuator for an electronic player piano. The prior art pedal actuator is combined with an upper unit, in which the key solenoids are incorporated for playing the keys. The prior art pedal actuator selectively steps on the pedals of the acoustic piano during the playback on the basis of pieces of music data so as to give the effects to the acoustic piano tones. Howeve the listeners feel the automatic playing slightly different from the original performance.

### SUMMARY OF THE INVENTION

It is therefore an important object of the present invention to provide an automatic player, which can faithfully play a music passage on various models of acoustic pianos.

The present inventors contemplated the problem, and noticed that the key actuators had inclined on the keys. In this situation, even if the key actuators were driven on the basis of a common piece of music data, those key actuators exerted the force on the keys at magnitude equivalent to that expressed by the common piece of music data, and only a component force gave rise to the key motion. This was the reason why the listeners felt the automatic playing different from the original performance.

To accomplish the object, the present invention proposes uniformly to adjust actuators to a proper relative position with respect to associated keys.

In accordance with one aspect of the present invention, there is provided a separate automatic player independent of a keyboard musical instrument, which has a fore-and-aft direction, a lateral direction crossing the fore-and-aft direction at right angle and an up-and-down direction normal to a plane defined by the fore-and-aft direction and the lateral direction, and the separate automatic player comprises a key driver unit including a key actuator unit having an array of key actuators selectively driving keys of the keyboard musical instrument for producing tones, a first regulator connected to the key actuator unit and moving the key actuator unit in the up-and-down direction so as to make the array of the keys in parallel to the upper surfaces of the keys and a second regulator connected to the key actuator unit and rotating the key actuator unit about a lateral line extending in parallel to the lateral direction so as to vary an angle between centerlines of the key actuators and a virtual plane defined by the lateral line and a vertical line normal to a floor where the keyboard musical instrument stands and a pedal driver unit selectively stepping on pedals of the keyboard musical instrument.

### BRIEF DESCRIPTION OF THE DRAWINGS

The features and advantages of the separate automatic player will be more clearly understood from the following description taken in conjunction with the accompanying drawings, in which

FIG. 1 is a perspective view showing a separate automatic player of the present invention which gets ready to perform a music passage on an upright piano,

FIG. 2 is a plane view showing the separate automatic player,

FIG. 3 is a partially cut-away front view showing the separate automatic player,

FIG. 4 is a side view showing the separate automatic player,

FIG. 5 is a front view showing a key driver unit incorporated in the separate automatic player,

FIG. 6 is a cross sectional view taken along line 6-6 in FIG. 5, and showing solenoid-operated key actuators incorporated in the key driver unit,

FIG. 7 is a partially cut-away front view showing the structure of a pedal driver unit, and

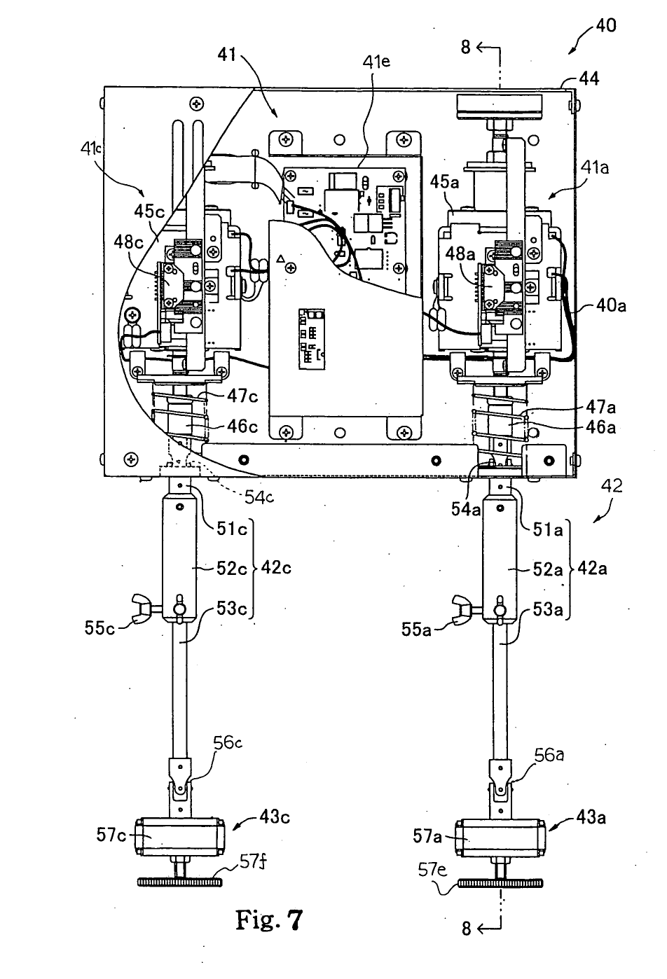

FIG. 8 is a cross sectional side view taken along line 8-8 in FIG. 7 and showing the structure of the pedal driver unit.

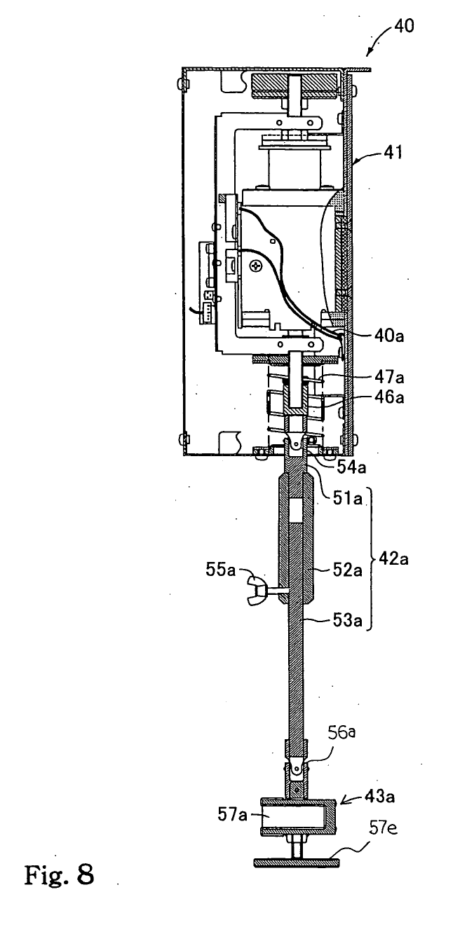

### DESCRIPTION OF THE PREFERRED EMBODIMENT

In the following description, term “front” is indicative of a position closer to a player, who is sitting on a stool for playing a music passage on a keyboard musical instrument, than a position modified with term “rear”. A line, which is drawn between a front position and a corresponding rear position, extends in a “fore-and-aft” direction, and the fore-and-aft direction crosses a “lateral direction” at right angle. An “up-and-down” direction is normal to a plane defined by the fore-and-aft direction and lateral direction.

### Separate Automatic Player Ready for Automatic Playing

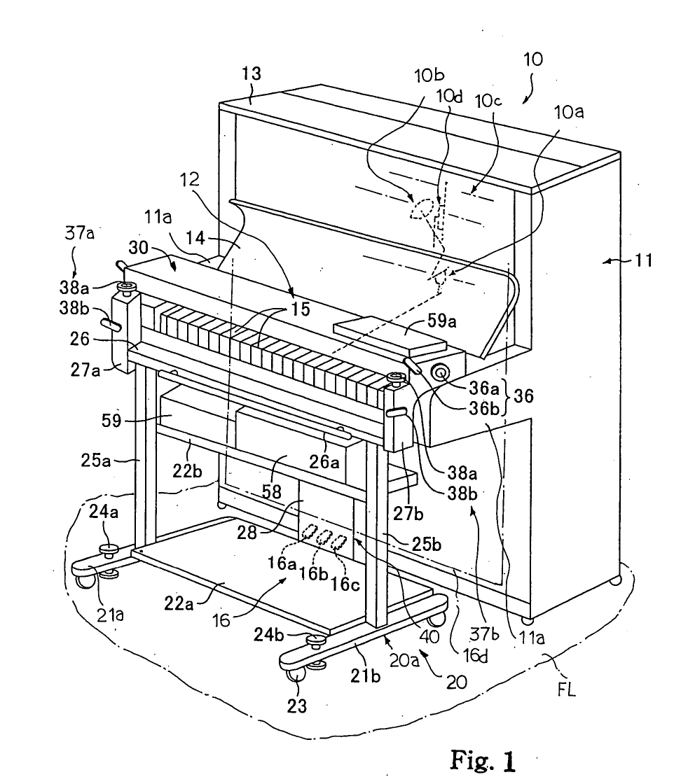

Referring to FIG. 1 of the drawings, an upright piano 10 is shown together with a separate automatic player 20 embodying the present invention. The upright piano 10 is installed on a floor FL, and the separate automatic player 20 is movable on the floor FL. Moreover, the separate automatic player 20 is compact and light enough for users to move it to another floor. Thus, the separate automatic player 20 is sharable with other acoustic pianos.

The separate automatic player 20 reenacts a performance, which is expressed by a set of music data codes. When a user wishes to enjoy the automatic playing, he or she moves the separate automatic player to the upright piano 10, and adjusts separate automatic player to a proper position in front of the upright piano 10. The user specifies the set of music data codes, and instructs the separate automatic player 20 sequentially to process the pieces of music data expressed by the set of music data codes. The separate automatic player 20 starts the data processing, and continues the data processing until the last piece of music data. The pieces of music data indicate the pitch of acoustic piano tones to be produced, loudness, timing to produce the acoustic piano tones, timing to decay the acoustic piano tones and effects to be imparted to the acoustic piano tones. The separate automatic player 20 is responsive to the pieces of music data, and plays the music passage on the acoustic piano 10.

### Acoustic Piano

The acoustic piano 10 includes a piano cabinet 11, a keyboard 12, an array of action units 10a, an array of hammers 10b, strings 10c and an array of dampers 10d. The keyboard 12 is mounted on a front portion of the piano cabinet 11, and the array of action units 10a, array of hammers 10b and strings 10c are installed inside the piano cabinet 11. The array of action units 10a is linked with the keyboard 12, and the array of hammers 10b is further linked with the array of action units 10a. The strings 10c are vertically and obliquely stretched, and are opposed to the array of hammers 10b. The array of dampers 11d is linked with the keyboard 12, and the dampers 10d are spaced from and brought into contact with the strings 10c depending upon the current key positions.

While a pianist is fingering on the keyboard 12, the action units 10a are selectively actuated, and the associated hammers 10b are driven for free rotation toward the strings 10c by the actuated action units 10a. The dampers 10d are spaced from the strings 10c before the hammers 10b reach the strings 10c, and, thereafter, the strings 10c are selectively struck with the hammers 10b at the end of the free rotation. Then, the strings 10c vibrate, and a sound board (not show) resonates with the strings 10c so as to produce the acoustic piano tones. After the release, the dampers 10d are brought into contact with the strings 10c, again, and the vibrations are decayed. Thus, the component parts 12, 10a, 10b, 10c and 10d behave as similar to those of a standard upright piano.

The piano cabinet 11 has a generally rectangular parallelepiped configuration, and a pair of arms 11a forwardly projects. The keyboard 12 is located on a key bed (not shown) which forms a part of the piano cabinet 11, and is located between key blocks (not shown) abutted to the arms 11a. A fall board 14 is rotatably supported by the arms 11a, and the keyboard 12 is exposed to and hidden from users by means of the fall board 14. Top boards define the upper boundary of the piano cabinet 11, and the front top board 13 is opened and closed.

The keyboard 12 includes black keys (not shown) and white keys 15, and the black keys (not shown) and white keys 15 are laid on the well-known pattern between the key blocks.(not shown). The black keys (not shown) and white keys 15 are respectively linked with the action units 10a, and the force, which is exerted on the front portions of the keys 15, is transmitted to the associated action units 10a. Thus, the black keys (not shown) and white keys 15 give rise to the series of actions described hereinbefore.

The upright piano 10 further includes a pedal mechanism 16. A soft pedal 16a, a muffler pedal 16b and a damper pedal 16c form the pedal mechanism 16 together with link works 16d, and the three pedals 16a, 16b and 16c forwardly projects front the lower portion of the piano cabinet 11. When a pianist steps on the soft pedal 16a, the acoustic piano tones are reduced in loudness. The muffler pedal 16b or a sostenuto pedal makes an acoustic piano tone reduced in loudness. When the pianist wishes to prolong the acoustic piano tones, he or she steps on the damper pedal 16c. While the pianist is performing a piece of music on the upright piano 10, he or she gives artificial expressions to the acoustic piano tones through the pedal system 16.

### Separate Automatic Player

The separate automatic player 20 includes a framework 20a, a key drive unit 30 and a pedal drive unit 40. The framework 20a is movable on the floor FL, and retains the key drive unit 30 over the keyboard 12 and the pedal drive unit 40 over the soft, muffler and damper pedals 16a/16b/16c.

Framework

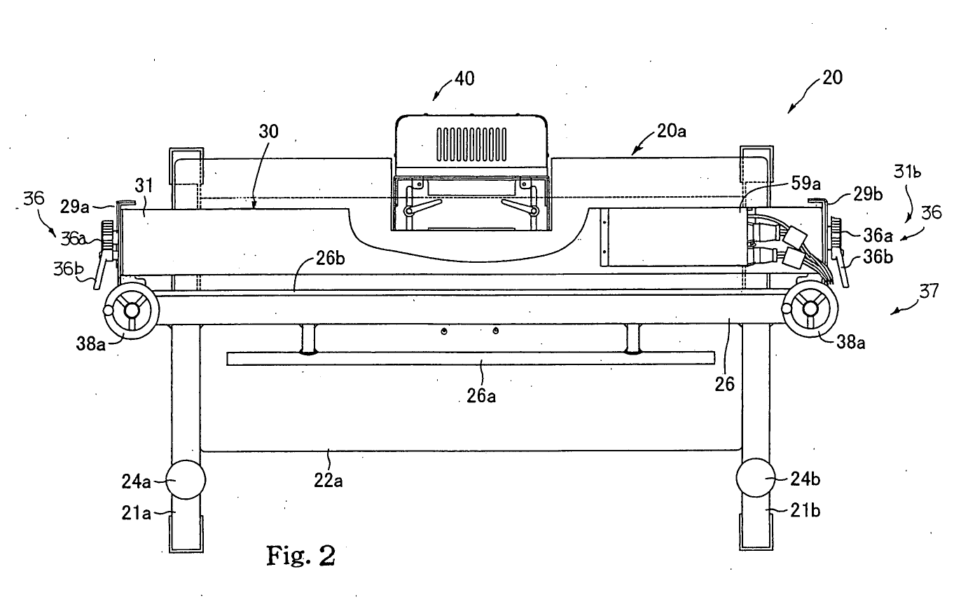

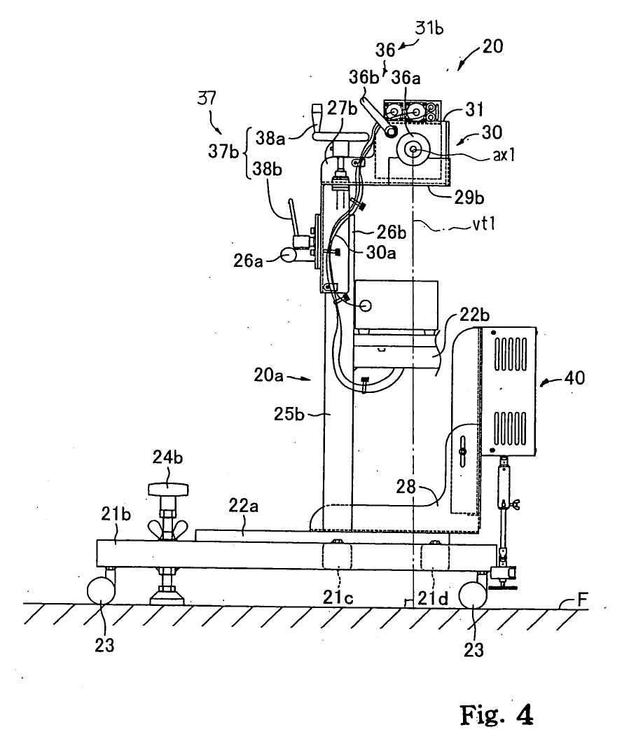

As will be better seen in FIGS. 2, 3 and 4, the framework 20a includes a pair of rigid bars 21a/21b, a pair of lateral bars 21c/21d, a base plate 22a and a pair of posts 25a/25b. The rigid bars 21a and 21b extend in the fore-and-aft direction in parallel to each other, and are spaced by a predetermined distance. The lateral bars 21c and 21d laterally extend between the rear portions of the rigid bars 21a and 21b in parallel to each other, and are connected at the right ends thereof to the rigid bar 21a and at the left ends thereof to the other rigid bar 21b. The lateral bar 21d is closer to the rear ends of the rigid bars 21a/21b than the other lateral bar 21c, and the lateral bar 21c is little bit offset from the middle points of the rigid bars 21a/21b toward the rear ends as shown in FIG. 4. The posts 25a/25b are upright on the rigid bars 21a/21b, and are located over the right end and left end of the lateral bar 21c. The base plate 22a has a rectangular top surface, and is connected to the rigid bars 21a/21b and lateral bars 21c/21d in such a manner as to bridge the gap between the rigid bars 21a and 21b. In other words, the gap between the rigid bars 21a and 21b is covered with the base plate 22a except the front zone.

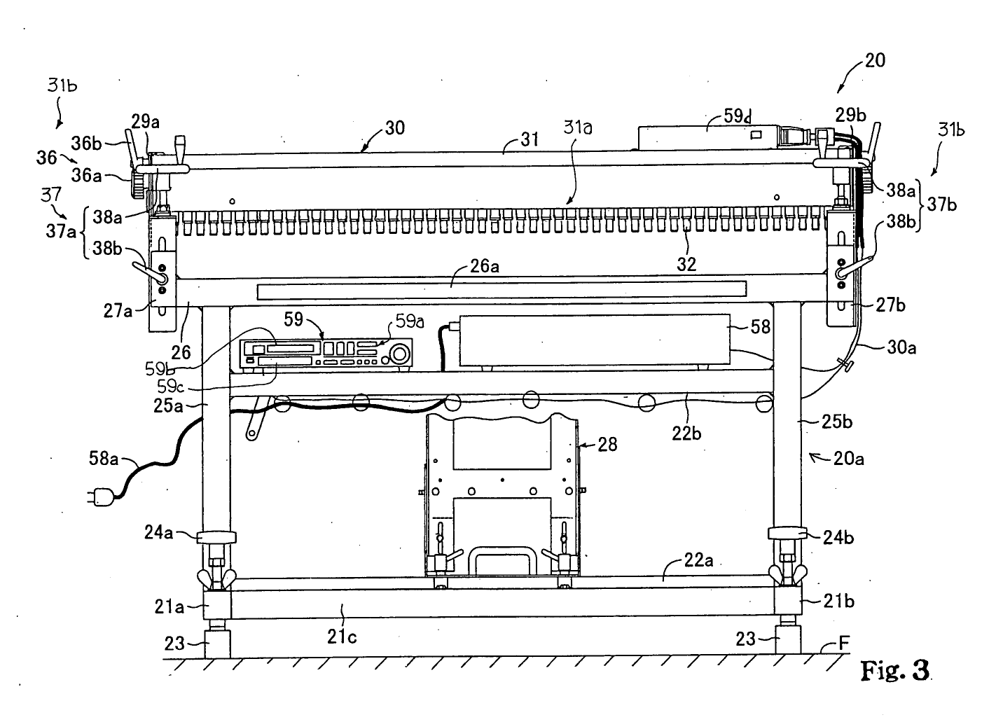

The framework 20a further includes a deck plate 22b, an upper beam 26, a pair of brackets 27a/27b and a retainer 28. The deck plate 22b is fixed to the posts 25a/25b, and is spaced in parallel from the base plate 22a. The upper beam 26 is fixed to the upper ends of the posts 25a/25b. The upper beam 26 laterally extends in parallel to the deck plate 22b and base plate 22a, and sideward projects over the posts 25a/25b. The bracket 27a is fixed to one end of the upper beam 26, and the other bracket 27b is fixed to the other end of the upper beam 26. The brackets 27a/27b rearward project from the upper beam 26, and the key drive unit 30 is supported by the pair of brackets 27a/27b. When the framework 20a stands by for the automatic playing in front of the upright piano 10, the brackets 27a/27b keep the key drive unit 30 over the keyboard 12. The retainer 28 is provided in a central area of a rear portion of the base plate 22a, and is fixed to the rear portion of the base plate 22a. The retainer 28 has a pair of L-letter shaped brackets and a frame (see FIGS. 3 and 4), and upwardly projects over the upper surface of the base plate 22a. The pedal actuator unit 40 is connected to the rear surface of the retainer 28. When the separate automatic player 20 stands by for the automatic playing, the retainer 28 keeps the pedal actuator unit 40 over the pedals 16a, 16b and 16c.

A grip bar 26a is fixed to the front surface of the upper beam 26, and a cushion belt 26b is adhered to the rear surface of the upper beam 26. The grip bar 26a is spaced from the upper beam 26 so that a user moves the separate automatic player 20 by drawings and pushing the grip 26a. The cushion belt 26b extends on the entire rear surface of the upper beam 26, and prevents the piano cabinet 11 from scratches at the collision therebetween.

The framework 20a further includes casters 23 and an anchors 24a/24b. In this instance, a pair of jacks 24a/24b serves as the anchor. The casters 20a are connected to the front end portions and rear end portions of the rigid bars 21a/21b, and downwardly projects from the lower surfaces of the rigid bars 21a/21b. Thus, the casters 23 are located at the four corners of the framework 20a. The casters 23 are able to roll about vertical center axes thereof, and permit a user to move the separate automatic player 20 in an arbitrary direction on the floor FL. The jacks 24a/24b are provided through the front end portions of the rigid bars 21a/21b. The jacks 24b/24b are held in threaded engagement with the rigid bars 21a/21b, and are projectable from and retractable into the rigid bars 21a/21b. When the user wishes to maintain the separate automatic player 20 at a certain position, he or she screws the jacks 24a/24b into the rigid bars 21a/21b. The jacks 24a/24b exert the force on the floor FL, and make the front casters 23 float over the floor FL. On the other hand, when the user wishes to move the separate automatic player 20 to another area on the floor FL, he or she retracts the jacks 24a/24b into the framework 20a, and makes the front casters 23 brought into contact with the floor FL, again. Then, the four casters 23 roll on the floor FL, and permit the user to move the separate automatic player 20 to the area.

Thus, the framework 20a retains the key drive unit 30 and pedal drive unit 40 over the keyboard 12 and pedals 16a/16b/16c during the automatic playing, and permits the user to move the separate automatic player 20 to another piano.

Key Drive Unit

The key driver unit 30 is broken down into a key actuator unit and an adjusting unit. The key actuator unit is responsive to a driving current signal so as selectively to depress and release the black keys (not shown) and white keys 15, and the adjusting unit permits the user three-dimensionally to vary the key actuator unit over the keyboard 12. Thus, a user optimizes the key actuator unit with respect to the keyboard 12 by means of the adjusting unit so that the separate automatic player 20 produces the acoustic piano tones, which the listeners feel same as those in the original performance.

In detail, the key driver unit 30 includes a housing 31, an array of key actuators 31a, an attitude changer 31b and an alignment device 35. The housing 31 and array of key actuators 31a as a whole constitute the key actuator unit, and the attitude changer 31b and alignment device 35 form in combination the adjusting unit.

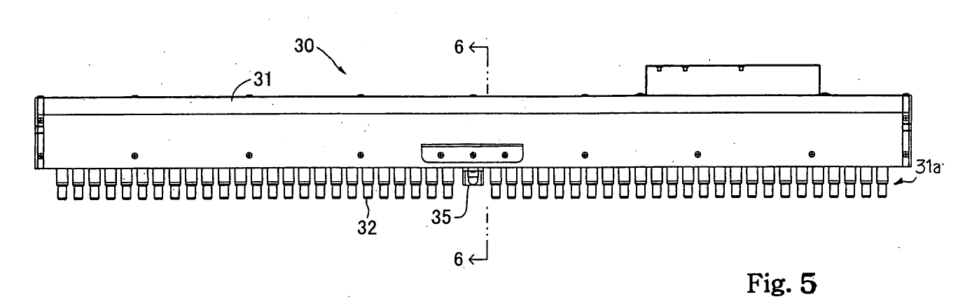

An inner space is defined in the housing 31, and the array of key actuators 31a is installed in the inner space. The housing 31 is supported through the attitude changer 31b by the brackets 27a/27b so that the user can change the attitude of the array of key actuators 31a with respect to the keyboard 12 by manipulating the attitude changer 31b. The attitude changer 31b permits the user to change the gap between the array of key actuators 31b and the black keys (not shown) and white keys 15 and the inclination of the array of key actuators 31b. The alignment device 35 is also supported by the housing 31 (see FIG. 5), and radiates a light beam onto the keyboard 12. The user aligns the light beam to the boundary between a gap between predetermined keys 15. In this instance, the eighty-eight keys 15 form the array of key actuators 31a, and the alignment device 35 is located at a relative position corresponding to the gap between the forty-fourth key 15 and the forty-fifth key. For this reason, when the user aligns the light beam with the gap between the keys 15, the key actuators 31a are properly located over the associated black keys (not shown) and white keys 15.

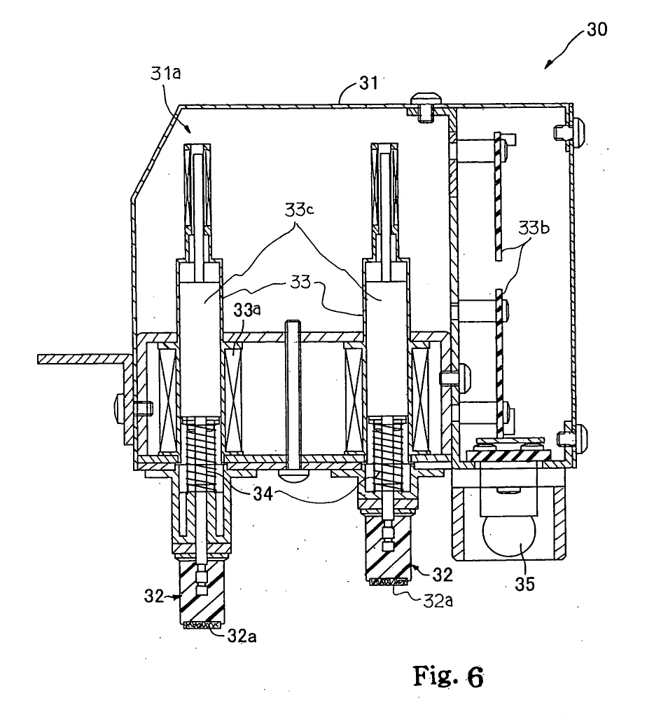

The housing 31 has a generally rectangular parallelepiped configuration, and yokes 33, on which solenoids 33a are wound, and a rigid circuit board 33b, on which a driver circuit (not shown) for the solenoids 33a are integrated, are bolted to the housing 31 as shown in FIG. 6. The yokes 33 and solenoids 33a form the array of key actuators 31a together with plunger heads 32, plungers 33c and return springs 34. The solenoids 33a are connected to the driver circuit (not shown), and the driving current signal is selectively supplied from the driver circuit (not shown) to the solenoids 33a. Power voltages are supplied to the driver circuit (not shown), and the driver circuit (not shown) is responsive to a control signal so as to adjust the driving signal to a target mean current and supply it to the solenoids as will be described hereinlater. The plungers 33c are movably inserted into the yokes 33, and the return springs 34 are inserted between the plungers 33c and the yokes 33. The return springs 34 always exert the elastic force on the associated plungers 33c in the upward direction so that the plungers 33c are retracted into the yokes 33. However, when the solenoids 33a are energized with the driving signal, the magnetic force is exerted on the associated plungers 33c in the downward direction, and downwardly project from the yokes 33. The plunger heads 32 are respectively secured to the lower ends of the plungers 33c, and have cushions 32a at the lower end thereof. In this instance, the cushions 32a are made of felt. The plungers 33c are brought into contact with the upper surfaces of the black keys (not shown) and the upper surfaces of the white keys 15 through the cushions 32a. The cushions 32a prevent the black keys (not shown) and white keys 15 from scratches, and extinguish noise at the strike.

The key actuators 31a are arranged in two rows, i.e., the front row assigned to the white keys 15 and the rear row assigned to the black keys (not shown). Since the black keys (not shown) have the height greater than the height of the white keys 15, the key actuators 31a for the black keys (not shown) have the plungers 33c shorter than those of the key actuators 31a for the white keys 15.

The attitude changer 31b permits the user three-dimensionally to change the attitude of the array of key actuators 31b with respect to the keyboard 12. In detail, a rotary unit 36 and an elevator 37 are incorporated in the attitude changer 31b. The rotary unit 36 is connected at one end to the housing 31 and at the other end to the elevator 37, and the elevator 37 is provided between the rotary unit 36 and the pair of brackets 27a/27b. The array of key actuators 31a has an axis of rotation ax1, which laterally extends between the rightmost key actuator 31a and the leftmost key actuator 31a, and the rotary unit 36 give rise to rotation of the array of key actuators 31a about the axis of rotation ax1. Thus, the rotary unit 36 causes the array of key actuators 31a to vary the angle of the key actuators 31a with respect to a virtual plane defined by the axis of rotation ax1 and a vertical line vt1 crossing the axis of rotation at right angle. On the other hand, the elevator 37 changes the distance between the axis of rotation and the brackets 27a/27b. The user independently moves up and down the both sides of the housing 31 by means of the elevator 37. For this reason, it is possible to make the housing 31 roll about a line in parallel to the fore-and-aft direction. Thus, the rotary unit 36 cooperates with the elevator 37 so as to optimize the attitude of the housing 31 and, accordingly, the array of key actuators 31a with respect to the keyboard 12. The rotary unit 36 includes a pair of brackets 29a/29b, a pair of side locks 36a and a pair of handles 36b. The brackets 29a/29b are respectively provided on both sides of the housing 31, and are supported by the elevator 37. The housing 31 is rotatably connected between the brackets 29a and 29b, and is secured to and released from the brackets 29a and 29b. The side locks 36a are supported by the brackets 29a and 29b. The side locks 36a makes the housing 31 pressed to the brackets 29a and 29b, and releases the housing 31 from the brackets 29a and 29b so as to permit the user to rotate the housing about the axis of rotation. The pair of handles 36b is connected to the housing 31, and offers a long radius of curvature to the user. When the user wishes to change the angle of the key actuators 31a, he or she manipulates the side locks 36a/36b so as to release the housing 31 from the brackets 29a/29b, and rotates the housing 31 with the handle 36b. When the center axes of the plungers 33c become normal to the upper surfaces of the black keys (not shown) and the upper surfaces of the white keys 15, he or she stops the rotation, and locks the housing 31 to the brackets 29a/29b by means of the side locks 36a, again.

The elevator 37 includes a pair of motion converters 38a and a pair of locks 38b. One of the motion converters 38a is provided in association with one of the locks 38b so as to form a side elevator 37a, and the other motion converter 38a and the other lock 38b also form another side elevator 37b. The side elevators 37a is provided between the bracket 27a and the bracket 29a, and the other side elevator 37b is provided between the other bracket 27b and the other bracket 29b. Since the side elevators 37a and 37b are independent of each other, the user may manipulate either side elevator 37a or 37b so as to make the housing 31 roll about the line in parallel to the fore-and-aft direction.

The motion converters 38a have respective wheels (see FIG. 2), and are rotatable about centerlines thereof vertical to the floor FL. The motion converters 38a convert the rotation of the wheels to the linear motion of the associated brackets 29a/29b. For this reason, the user moves the brackets 29a/29b upwardly and downwardly by manipulating the motion converters 38a. The locks 38b are respectively provided for the motion converters 38a, and permit the motion converters 38a to move the brackets 29a/29b in the up-and-down direction and keep-them at the current positions. When the user wishes to change the gap between the keyboard 12 and the plunger heads 32, he or she loosens the locks 38b, and moves the housing 31 upwardly and/or downwardly by means of the motion converters 38a. The user confirms that the gap is proper, then, he or she tightens the locks 38b, and makes the housing 31 unmoved.

As will be understood from the foregoing description, the user can optimize the attitude of the array of key actuators 31a over the keyboard 12 through the attitude changer 31b. In other words, the plunger heads 32 are evenly spaced from the associated black keys (not shown) and white keys 15, and the centerlines of the plungers 31c are normal to the upper surfaces of the black keys (not shown) and upper surfaces of the white keys 15. In this situation, the separate automatic player 20 gives rise to same key motion as that in the original performance on the basis of a reference piece of music data, and the listener feels the acoustic piano tones produced in the automatic playing identical with the original acoustic piano tones.

Pedal Actuator Unit

The pedal actuator unit 40 is broken down into a pedal actuator unit 41 and an adjuster 42. In this instance, the pedal actuator unit 40 drives the soft and damper pedals 16a/16c so that the muffler pedal 16b stands idle in the automatic playing. The pedal actuator 41 is responsive to a driving current signal so as selectively to step on the soft and damper pedals 16a, 16b and 16c. On the other hand, the adjuster 42 permits a user to optimize the relative position between the pedal actuator unit 41 and the soft and damper pedals 16a, 16b and 16c.

In detail, the pedal actuator unit 40 includes a housing 44, pedal actuators 41a/41c, a driver circuit 41e, universal joints 42a/42c and pedal clamps 43a/43c. The universal joints 42a/42c serves as the adjuster 42, and the housing 44, pedal actuators 41a/41c and pedal clamps 43a/43c as a whole constitute the pedal actuator unit 41. The housing 44 is supported by the framework 20a, and the brackets 28 keeps the housing 44 over the pedals 16a, 16b and 16c as described hereinbefore.

The pedal actuators 41a/41c and driver circuit 41e are provided inside the housing, and the driving current signal is selectively supplied from the driver circuit 41e to the pedal actuators 41a/41c. The soft pedal 16a and damper pedal 16c are clamped with the pedal clamps 43a and 43c, and the universal joints 42a/42c are inserted between the pedal actuators 41a/41c and the pedal clamps 43a/43c, respectively. The universal joints 42a/42c take up misalignment between the pedal actuators 41a/41c and the pedal clamps 43a/43c, and permits the pedal actuators 41a/41c vertically to exert the force on the soft pedal 16a and damper pedal 16c through the pedal clamps 43a/43c.

In more detail, the pedal actuators 41a/41c includes respective solenoids 45a/45c, respective plungers 46a/46c, respective return springs 47a/47c and respective plunger sensors 48a/48c. The solenoids 45a/45c are connected to the driver circuit 41, and the plungers 46a/46c downwardly project through the solenoids 45a/45c, respectively. The return springs 47a/47c is respectively inserted between the housing 44 and the plungers 46a/46c, and urges the plungers 46a/46c upwardly. For this reason, the plungers 46a/46c are retracted in the solenoids 45a/45c in the absence of the driving current signal. While the driving current signal is flowing through the solenoids 45a/45c, the solenoids 45a/45c create the magnetic fields around the plungers 46a/46c so as to exert the magnetic force on the plungers 46a/46c. The plungers 46a/46c downwardly project from the solenoids 45a/45c against the return springs 47a/47c, and pushes down the pedal clamps 43a/43c through the universal joints 42a/42c.

The universal joints 42a/42c includes respective upper rods 51a/51c, respective intermediate cylinders 52a/52c, respective lower rods 53a/53c, respective upper joints 54a/54c, bolts 55a/55c and respective lower joints 56a/56c. The upper rods 51a/51c are respectively connected at the upper end portions thereof to the lower end portions of the plungers 46a/46c by means of the upper joints 54a/54c, and the lower end portions of the upper rods 51a/51c are respectively inserted into the intermediate cylinders 52a/52c. The upper rods 51a/51c are secured to the intermediate cylinders 52a/52c by means of pins. The lower rods 53a/53c are respectively connected at the lower ends thereof to the pedal clamps 43a/43c by means of the lower joints 56a/56c, and the soft pedal 16a and damper pedal 16c, which have been inserted into gaps 57a/57b, are pressed to the inner surfaces of the pedal clamps 43a/43c by means of bolts 57e and 57f.

The upper portions of the lower rods 53a/53c are slidably inserted into the intermediate cylinders 52a/52c, respectively, and the upper portions of the lower rods 53a/53c are fixed to the intermediate cylinders 52a/52c by means of the bolts 55a/55c. When the user loosens the bolts 55a/55c, the lower rods 53a/53c become slidable in the intermediate cylinders 52a/52c. For this reason, the user adjusts the total length of the universal joints 42a/42c to the distance between the lower ends of the plungers 46a/46c and the soft and damper pedals 16a/16c by pushing the lower rods 53a/53c into and/or pulling out them from the intermediate cylinders 52a/52c, and drives the bolts 55a/55c into the intermediate cylinders 52a/52c for fixing the total length to the distance.

The upper joints 54a/54c have respective pairs of pins, and keep themselves inside the housing 44. The pins of each upper joint 54a/54c cross each other at right angle, and are rotatably connected to the lower end portions of the plungers 46a/46c and the upper end portions of the upper rods 51a/51c. For this reason, the upper joints 54a/54c permit the centerlines of the associated plungers 46a/46c to cross the centerlines of the upper rods 51a/51c at an arbitrary angle.

Similarly, the lower joints 56a/56c have respective pairs of pins. The pins of each lower joint 56a/56c cross each other at right angle, and are rotatably connected to the lower end portions of the lower rods 53a/53c and the upper end portions of the pedal clamps 43a/43c. For this-reason, the lower joints 56a/56c permit the centerlines of the associated lower rods 53a/53c to cross the centerlines of the pedal clamps 43a/43c at an arbitrary angle.

The upper and lower joints 54a/56a and 54c/56c permit the centerlines of the plungers 46a/46c to cross the centerlines of the pedal clamps 43a/43c at an arbitrary angle, and the intermediate cylinders 52a/52c and lower rods 53a/53c allow the total length of the universal joints 42a/42c and pedal clamps 43a/43c to be adjusted to the distance between the plungers 46a/46c and the pedal clamps 43a/43c. Thus, the user can optimize the relative position between the pedal actuators 41a and the soft and damper pedals 16a/16c by means of the adjuster 42.

Even if the centerlines of the plungers 46a/46c are offset from the centerlines of the pedal clamps 43a/43c, the plungers 46a/46c are connected through the universal joints 42a/42c to the pedal clamps 43a/43c, and the force is transmitted from the plungers 46a/46c through the universal joints 42a/42c to the pedal clamps 43a/43c. Moreover, the bolts 57e/57f keep the soft and damper pedals 16a/16c stable in the gaps 57a/57c. The bolts 57e/57f do not permit the soft and damper pedals 16a/16c to be separated from the pedal clamps 43a/43c, and prevent the soft and damper pedals 16a/16c from undesirable chattering. Thus, the force is surely exerted on the soft and damper pedals 16a/16c without any noise.

Additionally, the peal actuators 41a/41c, universal joints 42a/42c and pedal clamps 43a/43c are connected in series in the up-and-down direction so that the pedal driver unit 40 merely occupies a space narrower than the space occupied by the prior art pedal actuator disclosed in the U.S. patent.

Electronic System

Turning back to FIG. 3 of the drawings, a power source unit 58 and a controller 59 are put on the deck plate 22b. The power source unit 58 is rechargeable through a power cable 58a. Electric power is supplied from the power source unit 58 to the controller 59 and the driver circuits 33b/41e. Though not shown in the drawings, a data processor, a program memory and a working memory are incorporated in the controller 59, and the data processor is communicable with a local controller 59d and the driver circuit/plunger sensors 41e/48a/48c through cables 30a and 40a. The local controller 59 is connected to the driver circuit 33b and plunger sensors, which respectively monitor the plungers 33c, and carries out the feedback control on the key actuators 31a.

Upon completion of an initialization, a main routine program runs on the data processor, and conditionally branches to subroutine programs. While the data processor reiterates the main routine program, the data processor fetches user's instructions, which are given through buttons 59a, and produces visual images, which express current status of the data processing and/or prompt messages to the user, on a display window 59b.

A user is assumed to request the controller 59 a playback. The data processor reads out the titles of pieces of music from a compact disk on a tray 59c, and prompts the user to select a piece of music to be reproduced through the display window 59b. When the user specifies the piece of music to be reproduced, the data processor transfers a set of music data codes representative of the piece of music from the compact disk to the working memory, and starts the automatic playing.

While the data processor is sequentially processing the music data codes, the array of key actuators 31a and pedal actuators 41a/41c project and retracts the plungers 33c/46a/46c on the basis of the control signals supplied from the local controller 59a and controller 59 so as selectively to give rise to the key motion of black keys (not shown), key motion of white keys 15 and pedal motion of soft and damper pedals 16a/16c. The controller 59 takes the feedback signal supplied from the plunger sensors 48a/48c into account, and exactly controls the soft and damper pedals 16a/16c. The local controller 59d also forms the feedback control loops together with the plunger sensors, and exactly controls the black keys (not shown) and white keys 15. In other words, the separate automatic player 20 gives rise to not only the key motion but also the pedal motion in the automatic playing as similar to the human player in the original performance. The depressed black keys (not shown) and depressed white keys make the strings 10c produce the acoustic piano tones at the loudness equal to that in the original performance, and the effects are surely imparted to the selected acoustic piano tones. Thus, the separate automatic player reenacts the original performance without any fingering of a human pianist.

Setting Work

Subsequently, description is made on how the separate automatic player 20 is located at the proper relative position with respect to the upright piano 10. The jacks 24a/24b have been lifted over the floor FL, and the housing 31 and, accordingly, the array of key actuators 31a have been high enough not to be brought into collision with the keyboard 12. Moreover, the user have rearward turned the fall board 14 so as to expose the keyboard 12.

First, the user grips the grip bar 26a, and pushes and/or pulls the separate automatic player 20 so as to bring it near the upright piano 10. When the cushion belt 26b is brought into contact with the key slip, which defines the front boundary of the piano cabinet 11, the user stops the separate automatic player 20, and connects the power cable 58a to a socket.

Subsequently, the user turns on the alignment device 35. Then, the light beam is fallen onto the keyboard 12, and the user laterally moves the separate automatic player 20 until the light beam is aligned with the boundary between the predetermined keys 15. When the light beam is aligned with the boundary, the user moves down the jacks 24a/24b, and presses the jacks 24a/24b against the floor FL so as to make the front casters 23 float over the floor FL. When the jacks 24a/24b make the front casters 23 float over the floor FL by 5 millimeters, the user stops the jacks 24a/24b. The jacks 24a/24b do not permit the separate automatic player 20 unintentionally to move on the floor FL, and keep it stable on the floor FL. Thereafter, the user turns off the alignment device 35 so that the light is extinguished. Thus, the framework 20a is properly located at a target position with respect to the upright piano 10.

Subsequently, the user adjusts the key actuator unit 30 and pedal actuator unit 40 to proper angles and target distances. The user may firstly work on the key actuator unit 30 and, thereafter, on the pedal actuator unit 40 or vice versa. In detail, the user manipulates the locks 38b so as to release the elevator 37, and rotates the motion converters 38a/38b so as to move the housing 31 and, accordingly, the array of key actuators 31a downwardly. When all the plunger heads 32 are brought into contact with the upper surfaces of the associated black keys (not shown) and the upper surfaces of the associated white key 15, the user stops rotating, and locks the elevator 37, again. Although the plunger heads 32 are held in contact with the upper surfaces of the black keys (not shown) and the upper surfaces of the white keys 15, the centerlines of the plungers 33c may not be normal to the upper surfaces. For this reason, the user releases the rotary unit 36, and rotates the housing 31 and, accordingly, array of key actuators 31a. The angle between the centerlines of the plungers 33c and the virtual plane is varied. When the centerlines of the plungers 33c lie on the virtual plane, the user stops the rotation, and locks the rotary unit 36, again. In this situation, all the key actuators 31a are assumed to be energized at a predetermined amount of electric power. The plungers 33c exert force, the magnitude of which is equivalent to the predetermined amount of electric power, on the associated black keys (not shown) and associated white keys 15 without irregularity, and give rise to the key motion same as that in the original performance. This results in that the listeners feel the automatic playing same as the original performance.

The user adjusts the pedal driver unit 40 to the target length equal to the distance between the plungers 46a/46c and the soft and damper pedals 16a/16c as follows. Firstly, the user loosens the bolts 55a/55c, and permits the lower rods 53a/53c to be moved into and out of the intermediate cylinders 52a/52c. The user aligns the pedal clamps 43a and 43c with the soft and damper pedals 16a and 16c, and pushes the pedal clamps 43a and 43c toward the soft and damper pedals 16a and 16c. Then, the soft and damper pedals 16a and 16c are received in the spaces 57a and 57c. While the user is moving the pedal clamps 43a and 43c, the lower rods 53a/53c are moved into and out of the intermediate cylinders 52a/52c so as to increase and decrease the length, and the upper joints 54a/54c and lower joints 56a/56c permits the user to move the pedal clamps 43a/43c in the lateral direction and fore-and-aft direction. When the user confirms the soft and damper pedals 16a/16c received in the spaces 57a/57c, he or she drives the bolts 57e/57f into the pedal clamps 43a/43c, and fixes the soft and damper pedals 16a/16c to the pedal clamps 43a/43c, respectively.

When the user wishes to perform a piece of music on the keyboard through his or her fingering, he or she lifts the housing 31 and, accordingly, array of key actuators 31a, and spaces the jacks 24a/24b from the floor FL. Then, the casters 23 are allowed to roll on the floor FL, again. The user pulls the grip handle 26a, and moves the separate automatic player 20 to another area remote from the upright piano 10. The user puts a stool in front of the upright piano 10, and sits on the stool for the fingering.

As will be appreciated from the foregoing description, the separate automatic player 20 according to the present invention is equipped with the pedal driver unit 40 together with the key driver unit 30. The key driver unit 30 selectively depresses and releases the black keys (not shown) and white keys 15 on the basis of the pieces of music data, and the pedal driver unit 40 steps on and releases the soft and damper pedals 16a/16b so as to impart the effects to selected acoustic piano tones. Thus, the separate automatic player 20 according to the present invention faithfully reenacts the original performance without any fingering of a human pianist.

Moreover, the separate automatic player 20 is equipped with the cushion belt/casters 26b/23 and alignment device 35. The casters 23 permit a user smoothly to move the framework 20a on the floor FL, and the cushion belt and alignment device 35 make the framework 20a stand at the target position in front of the upright piano 10. Thus, the user easily brings the separate automatic player 20 exactly to the target position with respect to the upright piano 10.

Furthermore, the key driver unit 30 is equipped with not only the elevator 37 but also the rotary unit 36. The elevator 37 not only causes the array of key actuators 31a to advance to the keyboard 12 but also make the array: of actuators 31a in parallel to the array of black keys and white keys 15 through the cooperation between the side elevators 37a and 37b. On the other hand, the rotary unit 36 makes the plungers 33c vertical to the upper surfaces of the black keys (not shown) and the upper surfaces of the white keys 15. As a result, all the key actuators 31a exert the force on the black keys (not shown) and white keys 15 on the same condition. This means that the force is exerted on the black keys (not shown) and white keys 15 at the magnitude expressed by the pieces of music data. This results in that the key driver unit 30 gives rise to the key motion same as that in the original performance.

Another advantage of the cooperation between the elevator 37 and the rotary unit 36 is that the separate automatic player 20 is available for different models of the acoustic pianos. Even if the keyboards are different in height, even if the keyboards are differently sloped, the array of key actuators 31a are surely brought into contact with the upper surfaces of the black/white keys, and keeps the plungers 33c vertical to the upper surfaces of the black/white keys.

Although particular embodiments of the present-invention have been shown and described, it will be apparent to those skilled in the art that various changes and modifications may be made without departing from the spirit and scope of the present invention.

For example, a pedal driver unit may have three sets of pedal actuators, universal joints and pedal clamps, which are respectively assigned to the soft, muffler and damper pedals 16a, 16b and 16c.

A set of music data codes may be supplied from an external data source to the controller 59 through a public or private network.

The upright piano 10 does not set any limit to the technical scope of the present invention. The separate automatic player 20 may be used for an automatic playing on a grand piano. The acoustic piano, i.e., the upright and grand pianos, do not set any limit to the technical scope of the present invention. The separate automatic player 20 may reenact a performance on a mute piano, in which a hammer stopper and an electronic tone generating system are installed.

The two pedal actuators 41a/41c do not set any limit to the technical scope of the present invention. More than two or three pedal actuators may be incorporated in a pedal driver unit according to the present invention. A separate automatic player equipped with more than three pedal actuators may perform a piece of music on an electronic keyboard. The separate automatic player may be combined with a harpsichord or a celesta.

The solenoid-operated key actuators 31a and solenoid-operated pedal actuators 41a/41c do not set any limit to the technical scope of the present invention. The solenoid-operated key actuators 31a and solenoid-operated pedal actuators 41a/41c may be replaced with pneumatic actuators or electric motors.

In the above-described embodiment, the rotary unit is provided between the elevator and the housing. However, this feature does not set any limit to the technical scope of the present invention. In a modification, the rotary unit is supported by the framework, and the elevator is provided between the rotary unit and the housing. Another modification may have an elevator and a rotary unit connected in parallel to the housing 31.

Motors, hydraulic actuators, or pneumatic actuators may be connected to the axis of rotation ax1 and the brackets 29a/29b. In this instance, the user changes the attitude of the housing 31 with the assistance of the motors, hydraulic actuators or pneumatic actuators.

The pair of side elevators 37a/37b may be replaced with a single elevator.

The component parts of the embodiment are correlated with claim languages as follows. The housing 31 and array of key actuators 31a as a whole constitute a “key actuator unit”, and the elevator 37 and rotary unit 36 serve as a “first regulator” and a “second regulator”, respectively. The axis of rotation ax1 and vertical line vt1 are corresponding to a “lateral line” and a “vertical line”, respectively.

The cushion belt 26b and alignment device 35 as a whole constitute a “locator”, and are corresponding to a “first locating device” and a “second locating device”, respectively.

1. A separate automatic player independent of a keyboard musical instrument having a fore-and-aft direction, a lateral direction crossing said fore-and-aft direction at right angle and an up-and-down direction normal to a plane defined by said fore-and-aft direction and said lateral direction, comprising:
a key driver unit including
a key actuator unit having an array of key actuators selectively driving keys of said keyboard musical instrument for producing tones,
a first regulator connected to said key actuator unit and moving said key actuator unit in said up-and-down direction so as to make said array of said keys in parallel to the upper surfaces of said keys, and
a second regulator connected to said key actuator unit and rotating said key actuator unit about a lateral line extending in parallel to said lateral direction so as to vary an angle between centerlines of said key actuators and a virtual plane defined by said lateral line and a vertical line normal to a floor where said keyboard musical instrument stands; and
a pedal driver unit selectively stepping on pedals of said keyboard musical instrument.

2. The separate automatic player as set forth in claim 1, in which said second regulator keeps said centerlines of said key actuators normal to said upper surfaces of said keys staying at respective rest positions so that said key actuators independently exert force on said upper surfaces of said keys in directions vertical to said upper surfaces.

3. The separate automatic player as set forth in claim 2, in which said second regulator includes
a handle exerting moment on said key actuator unit so as to give rise to the rotation of said key actuator unit about said lateral line, and
a lock mechanism prohibiting said key actuator unit from said rotation.

4. The separate automatic player as set forth in claim 2, in which said first regulator cooperates with said second regulator so as to keep lower end portions of said key actuators vertically held in contact with said upper surfaces of said keys at said rest positions.

5. The separate automatic player as set forth in claim 4, in which said second regulator includes
a motion converter driven for rotation so as to convert the rotation to linear motion of said key actuator unit in said up-and-down direction, and
a lock mechanism prohibiting said key actuator unit from said linear motion.

6. The separate automatic player as set forth in claim 4, in which said first regulator includes
a first elevator connected to one end portion of said actuator unit so as to give rise to linear motion of said key actuator unit in said up-and-down direction,
a second elevator connected to another end portion of said actuator unit so as to give rise to linear motion of said key actuator unit in said up-and-down direction independently of said first elevator, and
locks independently prohibiting said first elevator and said second elevator from said liner motion.

7. The separate automatic player as set forth in claim 1, in which said pedal driver unit includes
pedal actuators for independently exerting force on said pedals,
pedal clamps fixed to said pedals, and
universal joints connected between said peal actuators and said pedal clamps so as to take up misalignment between said pedal actuators and said pedal clamps.

8. The separate automatic player as set forth in claim 7, in which said universal joints have respective telescopic portions so as to vary the length of said universal joints and locks prohibiting said telescopic portions from changing said length.

9. The separate automatic player as set forth in claim 1, in which said keyboard musical instrument is an acoustic piano having black keys, white keys and at least two pedals so that said black and white keys and said at least two pedals are driven by means of said key actuators and pedal actuators of said pedal driver unit.

10. The separate automatic player as set forth in claim 9, in which said first regulator cooperates with said second regulator so as to keep lower end portions of said key actuators vertically held in contact with said upper surfaces of said black and white keys staying at said rest positions.

11. The separate automatic player as set forth in claim 10, in which said second regulator includes
a motion converter driven for rotation so as to convert the rotation to linear motion of said key actuator unit in said up-and-down direction, and
a lock mechanism prohibiting said key actuator unit from said linear motion.

12. The separate automatic player as set forth in claim 10, in which said first regulator includes
a first elevator connected to one end portion of said actuator unit so as to give rise to linear motion of said key actuator unit in said up-and-down direction,
a second elevator connected to another end portion of said actuator unit so as to give rise to linear motion of said key actuator unit in said up-and-down direction independently of said first elevator, and
locks independently prohibiting said first elevator and said second elevator from said liner motion.

13. The separate automatic player as set forth in claim 9, in which said pedal driver unit further includes
pedal clamps fixed to said pedals, and
universal joints connected between said peal actuators and said pedal clamps so as to take up misalignment between said pedal actuators and said pedal clamps.

14. The separate automatic player as set forth in claim 13, in which said universal joints have respective telescopic portions so as to vary the length of said universal joints and locks prohibiting said telescopic portions from changing said length.

15. The separate automatic player as set forth in claim 1, further comprising a framework supporting said key driver unit over said keyboard and said pedal driver unit over said pedals and movable on said floor.

16. The separate automatic player as set forth in claim 15, in which said framework includes
casters rolling on said floor, and
an anchor prohibiting said casters from rolling on said floor.

17. The separate automatic player as set forth in claim 16, in which a pair of jacks serves as said anchor.

18. The separate automatic player as set forth in claim 15, further comprising a locator supported by said framework and assisting a user to locate said framework at a target relative position with respect to said keyboard musical instrument.

19. The separate automatic player as set forth in claim 18, in which said locator includes
a first locating device making said key driver unit and said pedal driver unit spaced by respective proper distances from a cabinet of said keyboard musical instrument in said fore-and-aft direction, and
a second locating device making said key actuators and said peal actuators laterally aligned with said keys and said pedals.

20. The separate automatic player as set forth in claim 19, in which said first locating device and said second locating device are implemented by a cushion belt brought into contact with a front surface of said cabinet and a light radiating device radiating a light beam to said keyboard, respectively.
